(19) United States
(12) Patent Application Publication
(10) Pub. No.: US 2006/0129891 A1
(43) Pub. Date: Jun. 15, 2006

(54) Software test framework

(75) Inventors: Sivaprasad V. Padisetty, Redmond, WA (US); Thirunavukkarasu Elangovan, Redmond, WA (US); Ulrich Lalk, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/996,979

(22) Filed: Nov. 23, 2004

(51) Int. Cl. G06F 11/00

(52) U.S. Cl. 714/38

(57) ABSTRACT

A reusable software test framework includes abstract and concrete classes as well as a user interface, for assisting in creating test scenarios from test items. A test item is a reusable test unit. The test item can be combined with other test items to create a test scenario that can be executed to perform a particular test for various pieces of software. Disassociated with the test item is a test context, test data, and test logic.

### FIELD OF THE INVENTION

The present invention relates generally to software testing, and more particularly, to a framework for facilitating the verification and validation of pieces of software.

### BACKGROUND OF THE INVENTION

The process of producing software is laborious, intellectually challenging, and error-prone. Like many engineered products, software undergoes testing to ensure that it performs or functions as designed by engineers and desired by customers. Whereas other engineered products are tested by using various different machinery and processes, software is tested by more software (“test software”) that must be written. FIG. 1 illustrates this problem and other problems in greater detail.

Test software is designed and written by a test team, which is common at many software organizations. The test team typically works side by side with a software development team. Laboring under many constraints, such as time and resources, the test team 102a typically produces monolithic test software 106a running on a test infrastructure code 104a also developed by the test team 102a. The problem with monolithic test software 106a is its lack of reusability. For example, suppose a piece of monolithic test software is a function for creating files. Suppose further that this function creates all files with a particular name for a particular word processing application. Such a test software design is monolithic in that data, among other things, are closely coupled to the test software. In other words, the function for creating files cannot be used to create other files with different names for different applications.

Another problem with monolithic test software is that small changes made to the test software force a complete recompilation, which can be quite time consuming for software products that have many lines of code. Another problem is that monolithic test software 106a is not scalable because it is domain-specific and is not written to address testing problems that are general in nature. Monolithic test software 106a is also not as reliable as other pieces of software because it must be written anew for each function and cannot leverage existing test code, which may have a history of reliable performance.

The most pernicious problem of all lies in software organizations that have multiple test teams, such as test teams 102a-102c. Given various constraints, each test team creates monolithic test software 106a -106c independent from other teams. Each test team 102a-102c also develops its own test infrastructure code 104a -104c so as to execute the monolithic test software 106a -106e and track test results. The test infrastructure code 104a -104c allows each test team to test specific requirements of a developed piece of software. With each test team 102a-102c developing its own test infrastructure code 104a -104c, duplication occurs. However, these duplications do not allow one test team to use another test team's test infrastructure code. Duplication also occurs at the creation of the monolithic test software 106a-106c in that common pieces of test software cannot be reused due to the monolithic design.

When an organization only has only one software product, the inefficiency of monolithic test software created by one test team may not be problematic. But in any software organization that develops numerous software products, that require testing by a multitude of test teams, having each team develop its own test infrastructure code and monolithic test software can cause the cost of software to rise. Without a better framework that facilitates reusability, scalability, and reliability, software may become too expensive for consumers to afford. Thus, there is a need for a system, method, and computer-readable medium for a better test framework while avoiding or reducing the foregoing and other problems associated with an existing system.

### SUMMARY OF THE INVENTION

In accordance with this invention, a system, method, and computer-readable medium for testing software is provided. The system form of the invention includes a display, a user input facility, and a user interface presented on the display, as well as a software test framework, which comprises test items for representing test concepts that are disassociated with a test context, test data, and test logic. The test context defines interrelated conditions in which the test item is to be executed. The test data defines the value of a test parameter. The test logic defines executable instructions to implement a test item.

In accordance with further aspects of this invention, a computer-readable medium form of the invention has one or more data structures stored thereon for use by a computing system to facilitate a software test framework. These data structures comprise a statement class for defining attributes and services connected with the treatment of a test item or a test scenario. These data structures also comprise a managed item class for defining attributes and services connected with a test item that is implemented with code that behaves and provides results defined by a predetermined architecture. The data structures further comprise an unmanaged item class for defining attributes and services connected with a test item that is implemented outside of the predetermined architecture.

In accordance with further aspects of this invention, a system form of the invention includes a display, a user input facility, and an application executed thereon for presenting a user interface on the display. The application comprises a first portion of the user interface for presenting a number of statements from which to build a test scenario. The number of statements includes a sequence statement for declaring executable instructions for causing test items to be executed in a particular order. The number of statements further includes a parallel statement for declaring executable instructions for causing test items to be executed in parallel.

In accordance with further aspects of this invention, a method form of the invention includes a computer-implemented method for testing software. The method comprises discovering published test items, each test item being disassociated with test context, test data, and test logic. The method further comprises creating test scenarios from combinations of test items. Each test scenario organizes as a tree structure with nodes that are linked together in a hierarchical fashion. The method also includes executing test scenarios using a software test framework to produce test results. The test results are analyzable to verify and validate a piece of software.

In accordance with further aspects of this invention, a computer-readable medium form of the invention includes a computer-readable medium having computer-executable instructions stored thereon that implements a method for testing software. The method comprises discovering published test items, each test item being disassociated with test context, test data, and test logic. The method further comprises creating test scenarios from combinations of test items. Each test scenario is organized as a tree structure with nodes that are linked together in a hierarchical fashion. The method also includes executing test scenarios using a software test framework to produce test results. The test results are analyzable to verify and validate a piece of software.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating monolithic test software;

FIG. 2A is a block diagram illustrating the decoupling of an exemplary test item from test context, test data, and test logic, in accordance with one embodiment of the present invention;

FIG. 2B is a block diagram illustrating the creation of a test scenario from one or more test items, zero or more statements, and zero or more test scenarios in accordance with one embodiment of the present invention;

FIG. 3A is a class diagram illustrating generalized categories of objects in a software test framework, in accordance with one embodiment of the present invention;

FIG. 3B is a pictorial diagram illustrating a user interface of a software test framework, in accordance with one embodiment of the present invention; and

FIGS. 4A-4H are process diagrams illustrating a method for testing software, in accordance with one embodiment of the present invention.

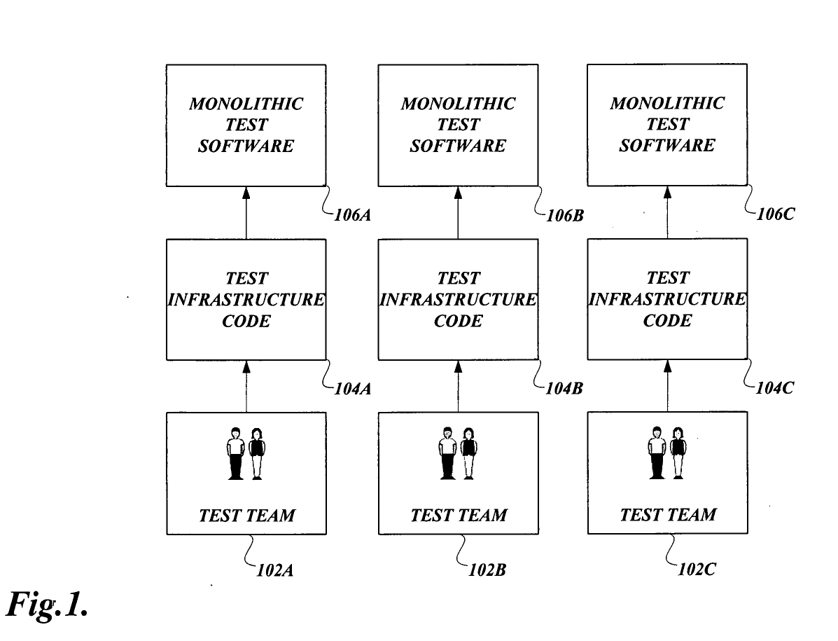

### DETAILED DESCRIPTION OF THE PREFERRED EMBODIMENT

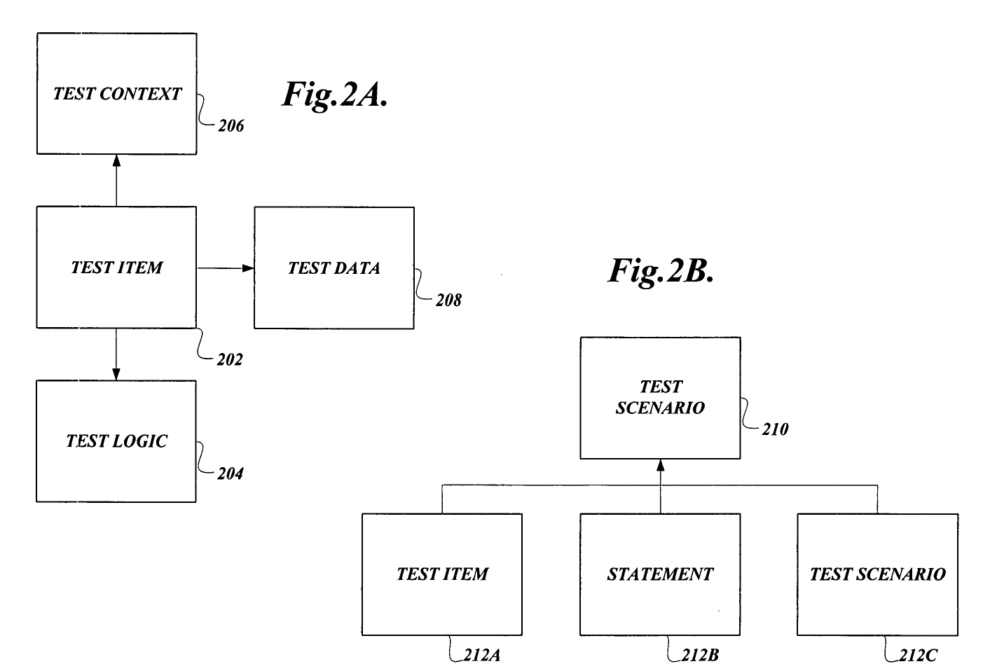

Various embodiments of the present invention provide a reusable software test framework, including abstract and concrete classes as well as a user interface, for assisting in creating test scenarios from test items. A test item 202 is a reusable test unit. See FIG. 2A. The test item 202 can be combined with other test items to create an entity that can be executed to perform a particular test for various pieces of software. Disassociated with the test item 202 is a test context 206. The test context 206 can be coupled to the test item 202 to define interrelated conditions in which the test item 202 is to be executed, such as a particular word processing application, among other things, and also provides facilities available to the test items (i.e. logging). A piece of test data 208 is also disassociated from the test item 202 but can be coupled to the test item 202 to define a particular test parameter. For example, if the test item 202 were associated with a function for creating files, the test data 208 may comprise the name of the file to be created by the test item 202. Also disassociated from the test item 202 are pieces of test logic 204, which are program instructions to implement the concept associated with the test item 202. Referring to the example above, suppose the test item 202 is associated with a function for creating files. The test logic 204 includes program instructions to implement the creation of files and can be written in any suitable language. One suitable language includes a customizable, tag-based language, such as XML. Another suitable language is C#. Many other suitable languages may be used.

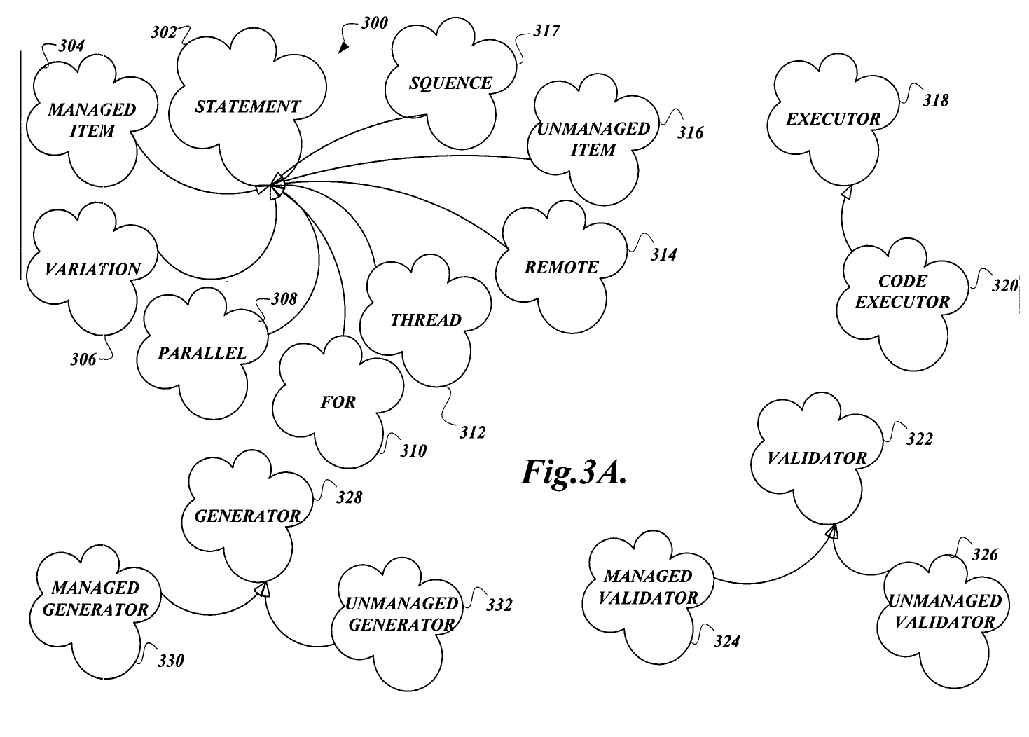

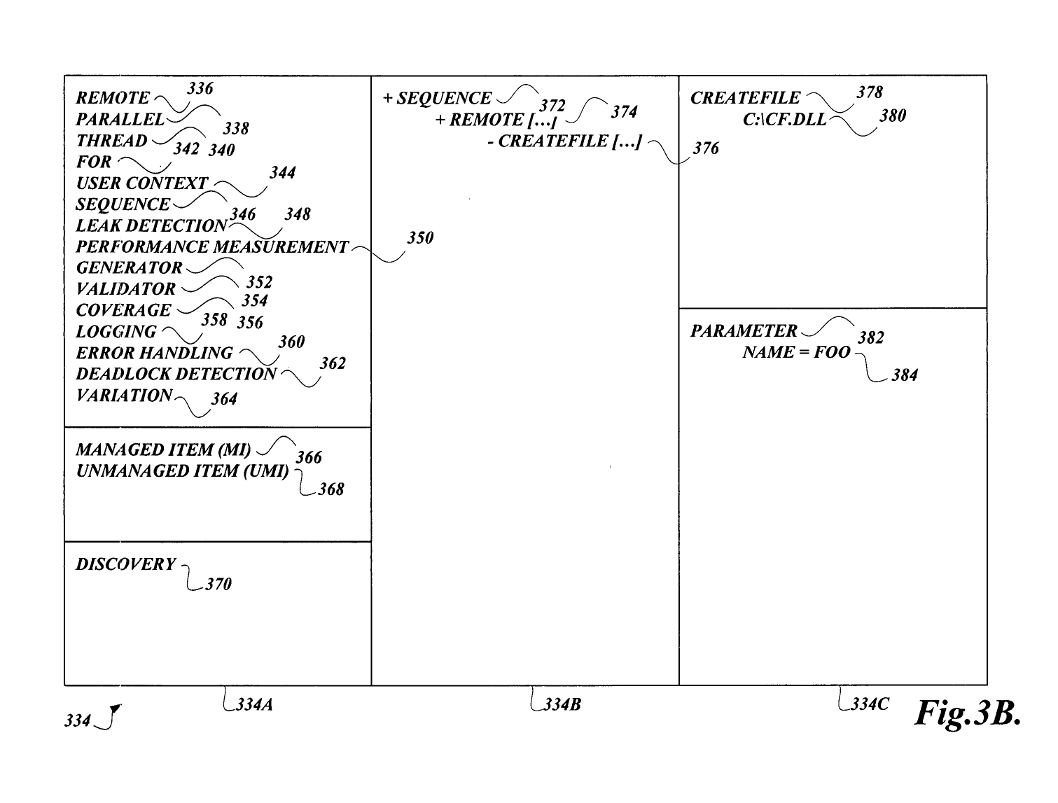

Test item, statement, and test scenario 212a-212c can be aggregated in various combinations to form a test scenario 210. See FIG. 2B. Whereas the coupling of test context 206, test data 208, and test logic 204 to the test item 202 (FIG. 2A) can be considered an internal binding, the aggregation of test items, statements, and test scenarios 212a-212c in various combinations to form the test scenario 210 can be considered an external binding of these test items, statements, and test scenarios 212a-212c. The test scenario is a named organizational scheme of test items, statements, and other test scenarios, which are executed by the software test framework. Many test scenarios can be formed to test pieces of software by combining various reusable test items, statements, and test scenarios. A statement is further described hereinbelow in connection with FIG. 3A.

A system 300 illustrates class diagrams in which each class is a generalized category that describes a group of more specific items, called objects. See FIG. 3A. A class is a descriptive tool used in an object-oriented program to define a set of attributes and/or a set of services (actions available to other parts of the program) that characterize any member (object) of the class. Essentially, each class defines the type of entities it includes and the ways those entities behave.

A statement abstract class 302 defines virtual attributes and virtual services representing a declaration in the system 300 in regard to the treatment of a test item or a test scenario comprising combinations of test items, statements, and test scenarios. A statement abstract class 302 counts among its members action statements that define how other statements should be treated (i.e. thread or parallel). A statement abstract class 302 counts among its members control statements that apply some action to other statements, which can be statements, test items or test scenarios. A managed item class 304 defines attributes and services connected with test items that are implemented with code that behaves and provides results defined by a predetermined architecture. One suitable predetermined architecture includes the .NET architecture of Microsoft Corporation. For a particular test item that is an instance of the managed item class 304, it implements a method run that receives a context data structure as a parameter and returns a Boolean result. An edge emanating from the managed item class 304 and terminating in an arrow-shaped figure at the statement class 302 indicates that there is an inheriting relationship between the managed item class 304 and the statement class 302.

An unmanaged item class 316 defines attributes and services connected with test items that are implemented outside of a predetermined architecture, such as the .NET architecture. The unmanaged item class 316 frees test developers to create test items from any suitable languages, such as C, C++, Java, are scripting languages, among others. The unmanaged item class 316 allows the execution of legacy test code, whereas the managed item class 304 allows the execution of test code written in the previously discussed predetermined architecture. An edge emanating from the unmanaged item class 316 and terminating in an arrow-shaped figure at the statement class 302 indicates that there is an inheriting relationship between the unmanaged item class 316 and the statement class 302. A variation class 306 defines attributes and services representing a grouping of statements together in combination and collectively defining a test unit. An edge emanating from the variation class 306 and terminating in an arrow-shaped figure at the statement class 302 indicates an inheriting relationship in which the variation class 306 derives certain attributes and services from the statement class 302. The variation class 306 allows the execution and reporting of variations of a test scenario performed to test a piece of software.

A parallel class 308 defines attributes and services connected with a statement for causing two or more test items to be executed in parallel. An edge emanating from the parallel class 308 and terminating with an arrow-shaped figure at the statement class 302 indicates an inheriting relationship in which the parallel class 308 derives certain attributes and services from the statement class 302. A sequence class 317 defines attributes and services connected with a statement for causing two test items to be executed in sequence. An edge emanating from the sequence class 317 and terminating with an arrow-shaped figure at the statement class 302 indicates an inheriting relationship in which the sequence class 317 derives certain attributes and services from the statement class 302. A “for” class 310 defines attributes and services connected with a looping control statement that executes statements and test items a specified number of times. An edge emanating from the “for” class 310 and terminating with an arrow-shaped figure at the statement class 302 indicates an inheriting relationship in which the “for” class 310 derives certain attributes and services from the statement class 302. A thread class 312 defines attributes and services connected with defining an independent path of execution for test items in a test scenario or a number of test scenarios. An edge emanating from the thread class 312 and terminating with an arrow-shaped figure at the statement class 302 indicates an inheriting relationship in which the thread class 312 derives certain attributes and services from the statement class 302. A remote class 314 defines attributes and services connected with the declaration of executing test items or test scenarios on a remote machine by specifying a location and accessing information, such as user name, domain, and session. An edge emanating from the remote class 314 and terminating with an arrow-shaped figure at the statement class 302 indicates an inheriting relationship in which the remote class 314 derives certain attributes and services from the statement class 302.

An abstract generator class 328 defines attributes and services in connection with the generation of data for parameters used with various test items and test scenarios. The managed generator class 330 defines attributes and services connected with generating data for use by managed code written in a suitable predetermined architecture, such as the .NET architecture. An edge emanating from the managed generator class 330 and terminating with an arrow-shaped figure at the generator class 328 indicates an inheriting relationship in which the managed generator class 330 derives certain attributes and services from the generator class 328. An unmanaged generator class 332 defines attributes and services connected with the generation of data for use by code written outside of the predetermined architecture previously discussed so as to include legacy test code. An edge emanating from the unmanaged generator class 332 and terminating with an arrow-shaped figure at the generator class 328 indicates an inheriting relationship in which the unmanaged generator class 332 derives certain attributes and services from the generator class 328. An abstract validator class 322 defines attributes and services connected with the validation of the result of the execution of a test item. A managed validator class 324 defines attributes and services connected with validating managed code written in a predetermined architecture previously discussed. An edge emanating from the managed validator class 324 and terminating with an arrow-shaped figure at the validator class 322 indicates an inheriting relationship in which the managed validator class 324 derives certain attributes and services from the validator class 322. An unmanaged validator class 326 defines attributes and services connected with validating data for unmanaged code written outside of a predetermined architecture discussed previously. An edge emanating from the unmanaged validator class 326 and terminating with an arrow-shaped figure at the validator class 322 indicates an inheriting relationship in which the unmanaged validator class 326 derives certain attributes and services from the validator class 322. An abstract executor class 318 defines attributes and services connected with an execution engine that prescribes how test items and test scenarios will be executed. A code executor class 320 defines attributes and services connected with a particular execution engine, which inherits certain attributes and services from the abstract executor class 318 (visually illustrated by an edge emanating from the code executor class 320 and terminating with an arrow-shaped figure at the abstract executor class 318).

A user interface 334 for a scenario test framework, consisting of implementations of abstract and concrete classes, and which assists in building test scenarios, is illustrated at FIG. 3B. The user interface 334 includes a first portion 334a that presents a number of statements for a test developer to select to build a test scenario. Many of these statements are implementations of classes described in the class diagram 300. See FIG. 3A.

A remote statement 336 declares executable instructions for causing test items or test scenarios to be executed on a remote computer by defining the location of the remote computer and access information, such as user name. A parallel statement 338 declares executable instructions for causing test items or test scenarios to be executed in parallel. A thread statement 340 declares executable instructions for causing an independent path of execution to occur for a particular test item or a group of test items under a test scenario. A for statement 342 declares executable instructions for implementing a loop in which a test item or a test scenario is executed for a specified number of times. A user context statement 344 declares executable instructions that specify the level of user access in which to execute test items or test scenarios, such as an administrator or a guest user. A sequence statement 346 declares executable instructions for causing test items or test scenarios to be executed in a particular order. A leak detection statement 348 declares executable instructions for detecting whether a memory leak has occurred after the execution of a test item or a test scenario. A performance measurement statement 350 declares executable instructions for measuring computer performance, such as CPU usage, among other things, after execution of a test item or test scenario. A generator statement 352 declares executable instructions for generating data for a test item. A validator statement 354 declares executable instructions for validating data for a test item. A coverage statement 356 declares executable instructions for determining the code coverage of the execution of a particular test item or test scenario. A logging statement 358 declares executable instructions for logging test activities in connection with a test item or a test scenario. An error handling statement 360 declares executable instructions for reporting errors generated as a result of the execution of a test item or a test scenario. A deadlock detection statement 362 declares executable instructions for determining whether a deadlock or a situation in which two or more programs are each waiting for a response from the other before continuing. A variation statement 364 declares executable instructions in order to group together a set of test items for execution.

A managed item (MI) statement 366 allows a test developer to insert a particular piece of test code written in a predetermined architecture, such as the .NET architecture. An unmanaged item (UMI) statement 368 allows a test developer to insert test code, which includes legacy test code or code written external to the predetermined architecture previously discussed. A section of the first portion 334a allows a test developer to execute a discovery query 370 to find test items so as to form a desired test scenario. A second portion 334b of the user interface 334 is a working area in which a test developer develops a test scenario in a suitable form. One suitable form includes a tree data structure containing one or more nodes that are linked together in a hierarchical fashion. For example, a sequence statement at line 372 defines a root node by the dragging and dropping of the sequence statement 346 from the first portion 334a. Line 374 defines another node of the tree structure formed by the dragging and dropping of the remote statement 336. Line 376 illustrates a create file test item created by dragging and dropping either a managed item statement 366 or the unmanaged item statement 368 onto the second portion 334b. When either the managed item statement 366 or the unmanaged item statement 368 is dropped onto the second portion 334b, a third portion 334c discloses suitable pieces of code, such as the create file function 378 stored at a location indicated by line 380, which is “C:/CF.DLL”. If the test item, such as the test item create file on line 376, requires parameters, the third portion 334c discloses line 382 where the test developer may specify a parameter on line 384, such as the name “FOO”.

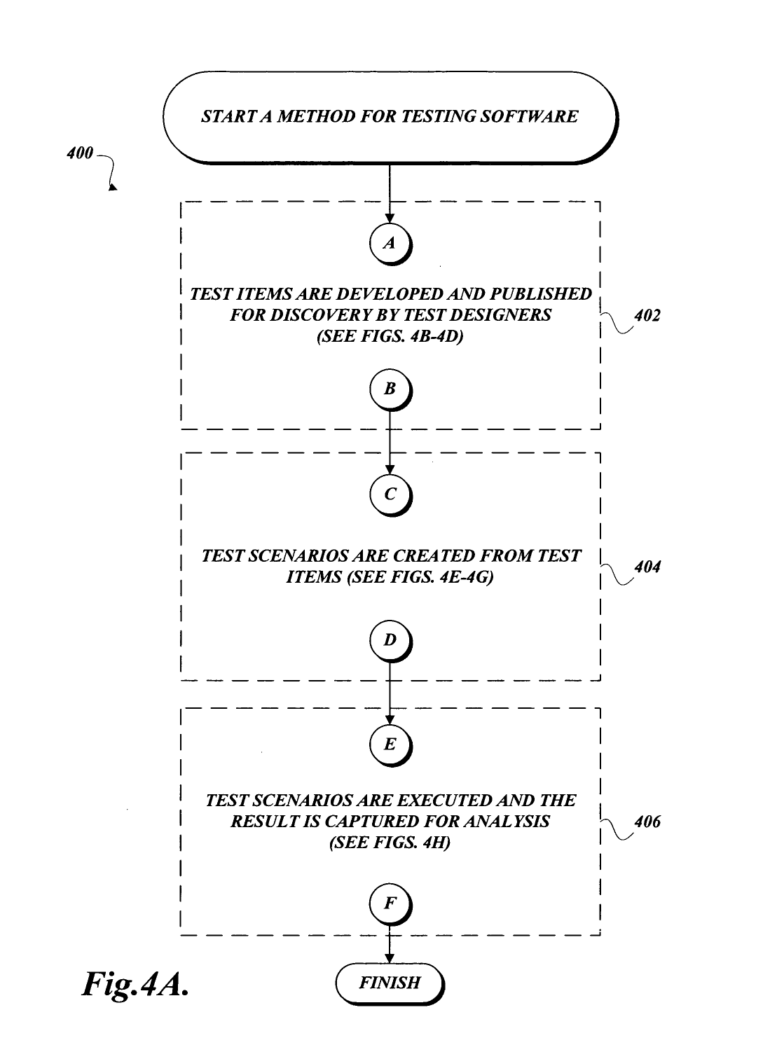

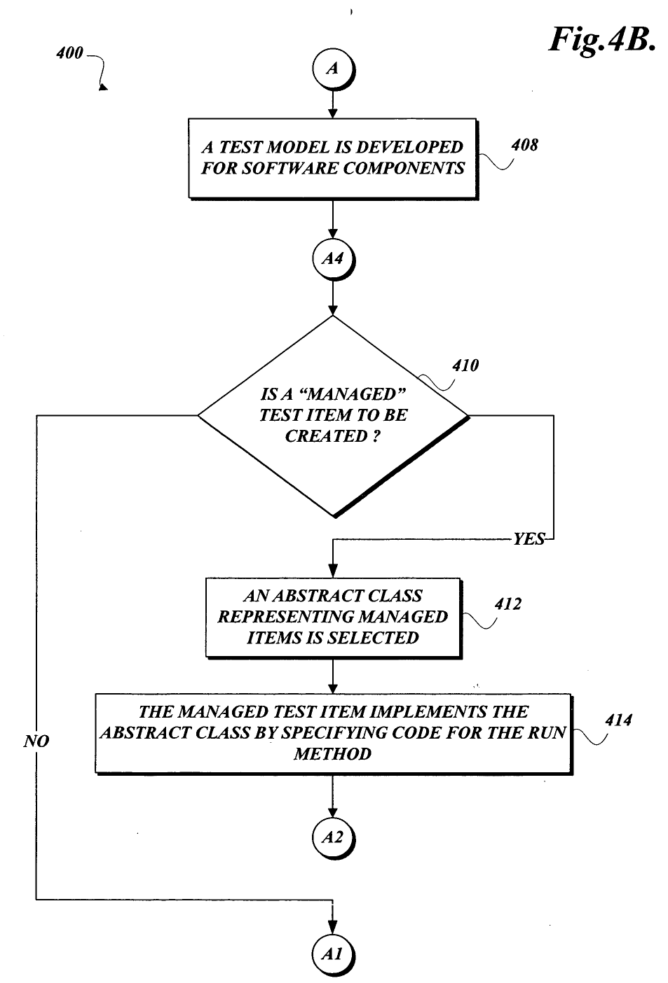

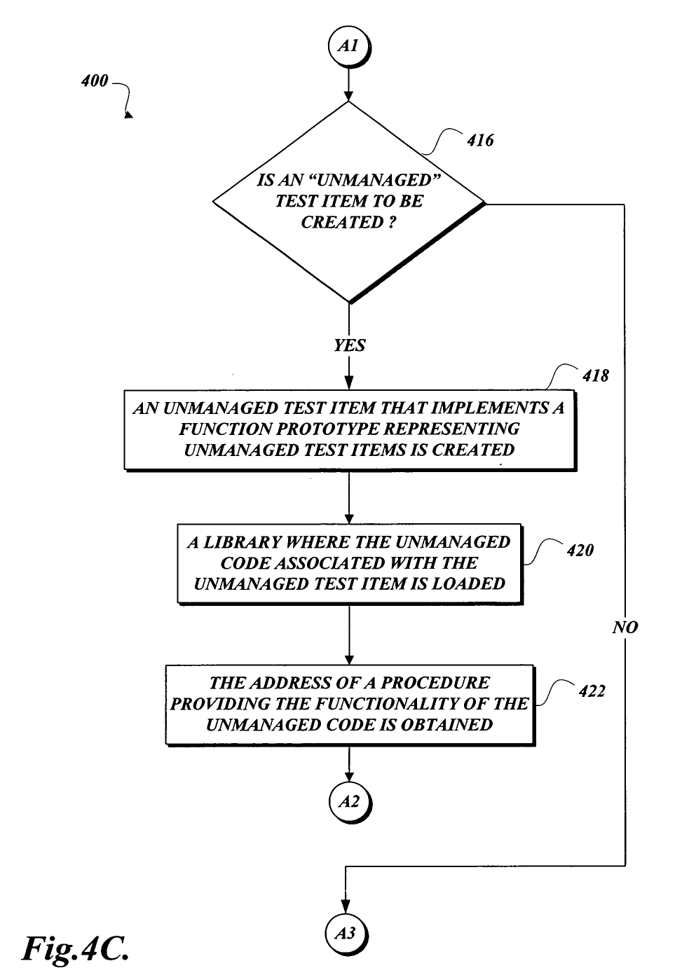

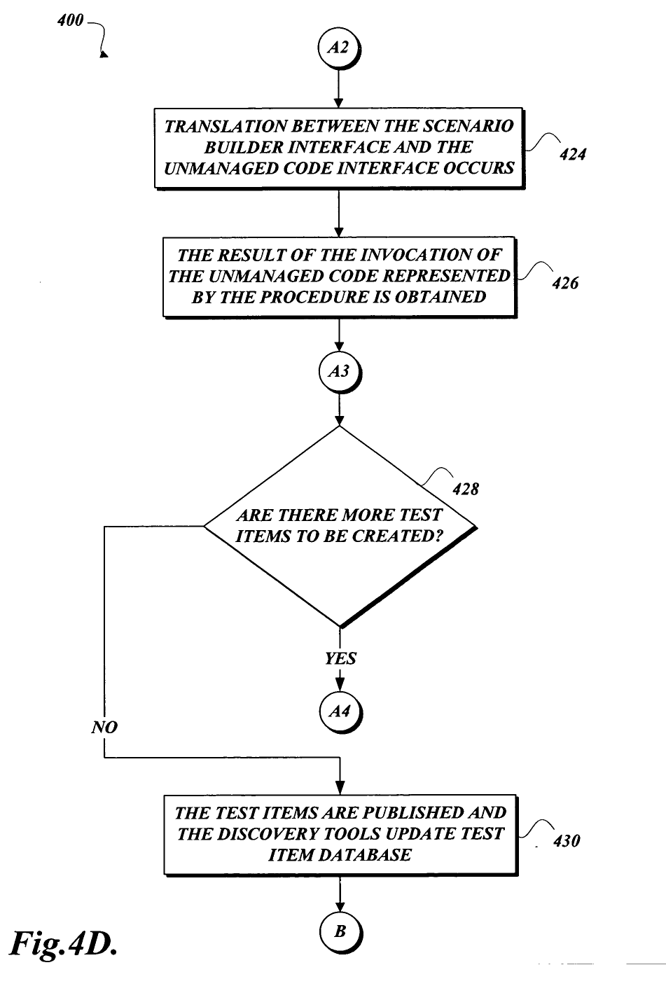

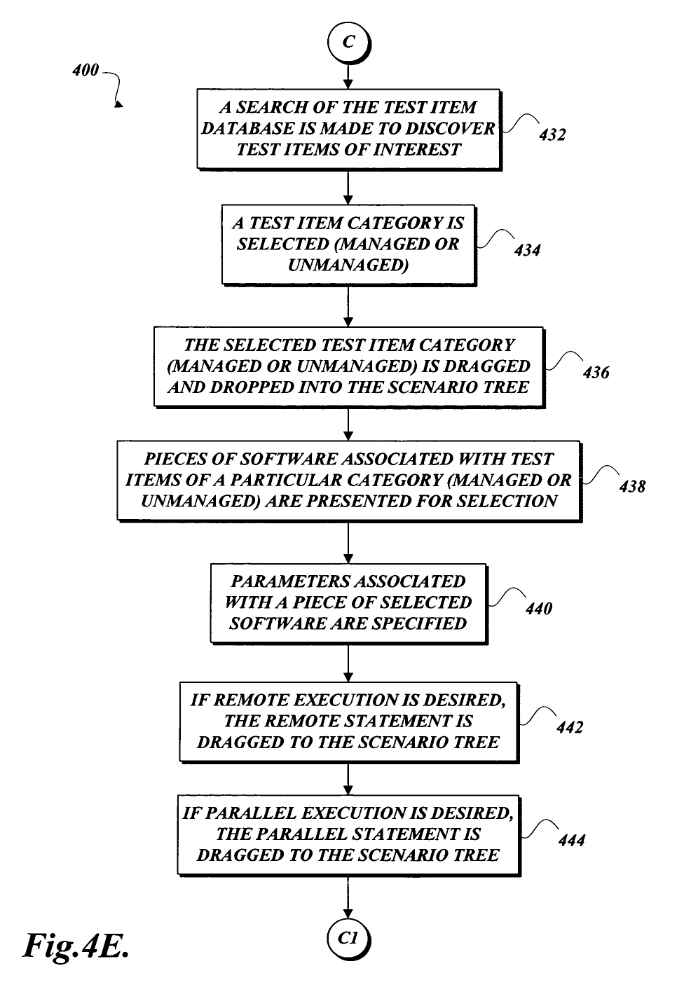

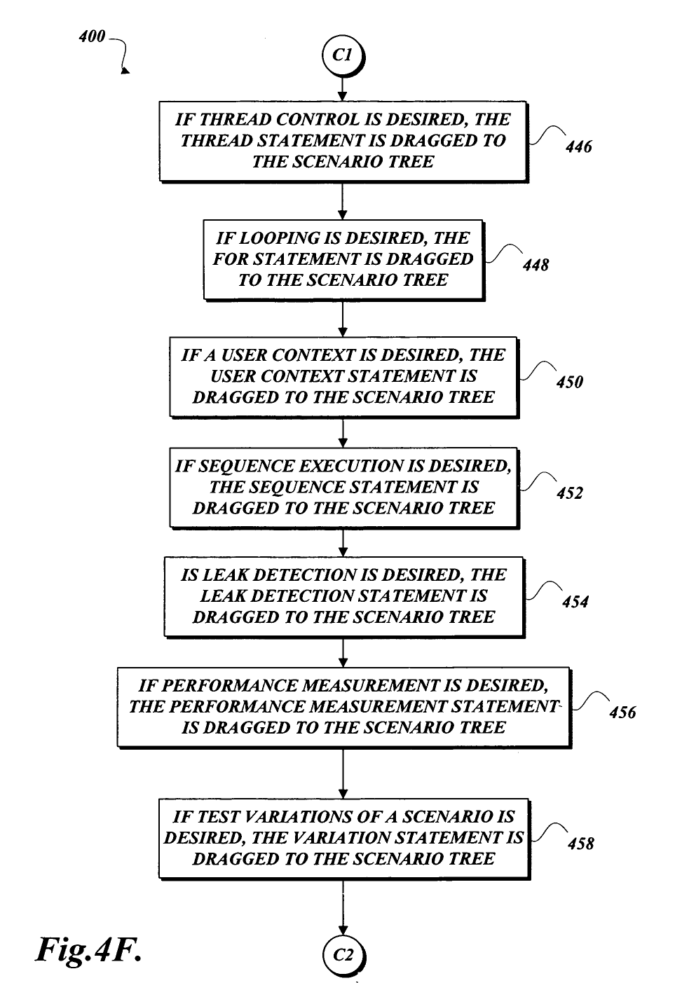

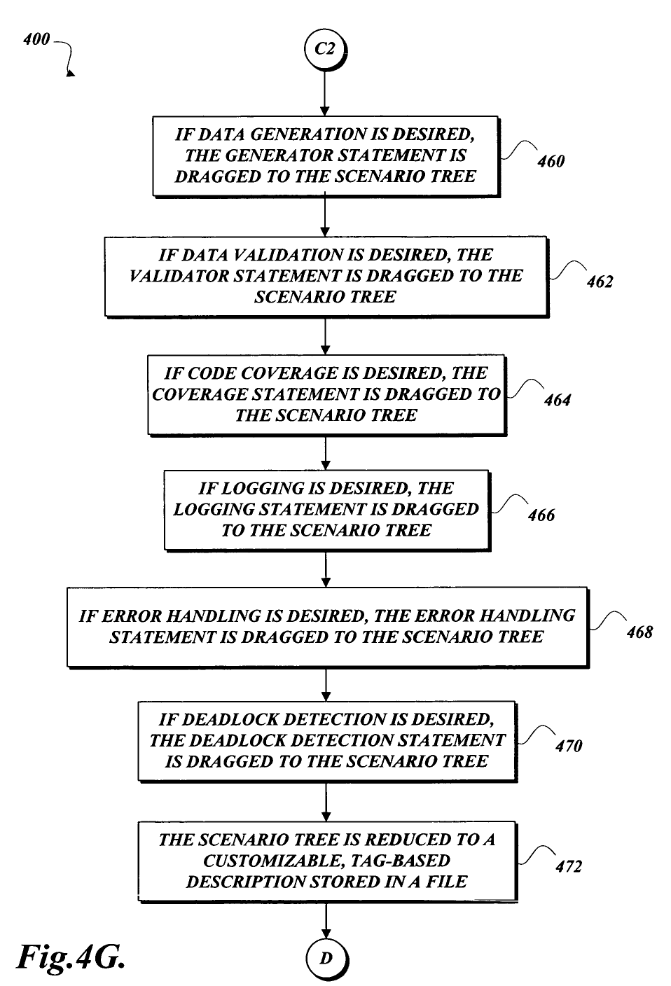

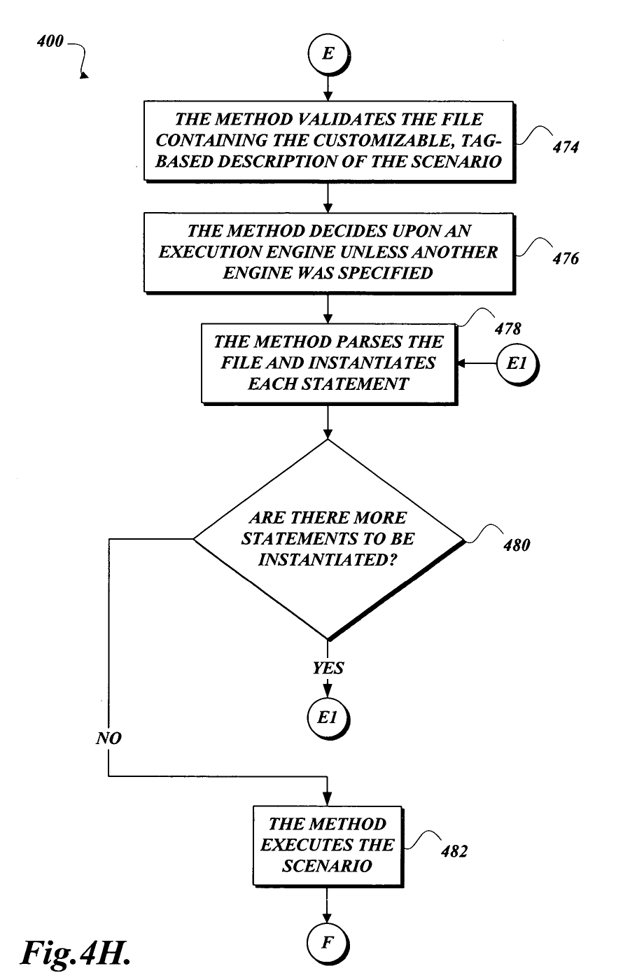

FIGS. 4A-4H illustrate a method 400 for testing software. For clarity purposes, the following description of the method 400 makes references to various elements illustrated in connection with the test item 202 (FIG. 2A); the test scenario 210 (FIG. 2B); and statements 336-368 of the user interface 334 (FIG. 3B). From a start block, the method 400 proceeds to a set of method steps 402, defined between a continuation terminal (“terminal A”) and an exit terminal (“terminal B”). The set of method steps 402 describes that test items are developed and published for discovery by test designers.

From terminal A (FIG. 4B), the method 400 proceeds to block 408 where a test model is developed for software components. The method 400 then continues to another continuation terminal (“terminal A4”). From terminal A4 (FIG. 4B), the method 400 proceeds to decision block 410 where a test is performed to determine whether a managed test item is to be created. If the answer is NO to the test at decision block 410, the method 400 proceeds to another continuation terminal (“terminal A1”). Otherwise, the answer to the test at decision block 410 is YES, and the method 400 proceeds to block 412 where an abstract class representing managed items is selected. At block 414, the managed test item implements the abstract class by specifying code for the run method. The run method is executed by the scenario framework during execution of a test scenario or a test item. The method 400 then proceeds to another continuation terminal (“terminal A2”).

From terminal A1 (FIG. 4C), the method 400 proceeds to decision block 416 where a test is performed to determine whether an unmanaged test item is to be created. If the answer to the test at decision block 416 is NO, the method 400 proceeds to another continuation terminal (“terminal A3”). Otherwise, the answer to the test at decision block 416 is YES, and the method 400 proceeds to block 418 where an unmanaged test item that implements a function prototype representing unmanaged test items is created. A code library, such as a dynamic link library, where the unmanaged code associated with the unmanaged test item is loaded. See block 420. At block 422, the address of a procedure providing the functionality of the unmanaged code is obtained. The method then continues to terminal A2.

From terminal A2 (FIG. 4D), translation between the scenario builder interface and the unmanaged code interface occurs. See block 424. The translation of this particular block allows a test designer to take information from the unmanaged code and express it in more comprehensible terms to the scenario framework and vice versa. See block 424. At block 426, the result of the invocation of the unmanaged code represented by the procedure is obtained. The method 400 then proceeds to terminal A3 (FIG. 4D). From terminal A3, the method 400 proceeds to decision block 428 where a test is performed to determine whether there are more test items to be created. If the answer to the test at decision block 428 is YES, the method 400 proceeds to terminal A4 to loop back to decision block 410, and the above-described processing steps are repeated. Otherwise, the answer to the test at decision block 428 is NO, and the method 400 proceeds to block 430 where the test items are published and the discovery tools update the test item database to aid in the discovery of test items for creating test scenarios. The method 400 then continues to exit terminal B.

From exit terminal B (FIG. 4A), the method 400 proceeds to a set of method steps 404 defined between a continuation terminal (“terminal C”) and an exit terminal (“terminal D”). The set of method steps 404 define steps where test scenarios are created from test items. From terminal C (FIG. 4E), the method 400 proceeds to block 432 where a search of the test item database is made to discover test items of interest. The discovery query 370 of the first portion 334a of the user interface 334 (FIG. 3B) is used. A test item category is selected (managed or unmanaged). See block 434. See also lines 366, 368 of the first portion 334a of the user interface 334. The selected test item category (managed or unmanaged) is dragged and dropped into the scenario tree. See block 436. See also the second portion 334b where a scenario tree is being defined. Pieces of software associated with test items of a particular category (managed or unmanaged) are presented for selection. See block 438. See also lines 378, 380 of the third portion 334c of the user interface 334 where a piece of software “create file” is made available for a test designer to select. Parameters associated with a piece of selected software are specified. See block 440. See also lines 382, 384 of the third portion 334c of the user interface 334. If remote execution is desired, the remote statement 336 is dragged to the scenario tree. See block 442. If parallel execution is desired, the parallel statement 338 is dragged to the scenario tree. See block 444. The method 400 then continues to another continuation terminal (“terminal C1”). From terminal C1 (FIG. 4F), the method proceeds to block 446 where if thread control is desired, the thread statement 340 is dragged to the scenario tree. If looping is desired, the for statement 342 is dragged to the scenario tree. See block 448. If a user context is desired, the user context statement 344 is dragged to the scenario tree. See block 450. If sequence execution is desired, the sequence statement 346 is dragged to the scenario tree. See block 452. If leak detection is desired, the leak detection statement 348 is dragged to the scenario tree. See block 454. If performance measurement is desired, the performance measurement statement 350 is dragged to the scenario tree. See block 456. If test variations of a scenario are desired, the variation statement 364 is dragged to the scenario tree. See block 458. The method 400 then continues to another continuation terminal (“terminal C2”).

From terminal C2 (FIG. 4G), the method 400 proceeds to block 460 where if data generation is desired, the generator statement 352 is dragged to the scenario tree. A generator connected with the generator statement 352 is associated with a parameter and is preferably used to generate a run time value for the parameter. If data validation is desired, the validator statement 354 is dragged to the scenario tree. See block 462. If code coverage is desired, the coverage statement 356 is dragged to the scenario tree. See block 464. If logging is desired, the logging statement 358 is dragged to the scenario tree. See block 466. If error handling is desired, the error handling statement 360 is dragged to the scenario tree. See block 468. If deadlock detection is desired, the deadlock detection statement 362 is dragged to the scenario tree. See block 470. The scenario tree is then reduced to a customizable, tag-based description stored in a file. See block 472. Any suitable customizable, tag-based language may be used, such as XML. The method 400 then continues to the exit terminal D.

From the exit terminal D, the method 400 continues to a set of method steps 406 defined between a continuation terminal (“terminal E”) and an exit terminal (“terminal F”). The set of method steps 406 defines steps where test scenarios are executed, and the result is captured for analysis. From terminal E (FIG. 4H), the method 400 validates the file containing the customizable, tag-based description of the scenario. See block 474. The method then decides upon an execution engine unless another engine was specified by the test designer. See block 476. The method parses the file and instantiates each statement. See block 478. A test is performed at decision block 480 to determine whether there are more statements to be instantiated. If the answer to the test at decision block 480 is YES, the method 400 continues to another continuation terminal (“terminal E1”). From terminal E1 (FIG. 4H), the method 400 loops back to block 478 where the above-described processing steps are repeated. If the answer to the test at decision block 480 is NO, the method executes the scenario. See block 482. The method 400 then proceeds to the exit terminal F and terminates execution.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. In a computer system including a display, a user input facility, and a user interface presented on the display, a software test framework comprising:
test items for representing test concepts that are disassociated with a test context, test data, and test logic, the test context defining interrelated conditions in which the test item is to be executed, the test data defining the value of a test parameter, and the test logic defining executable instructions to implement a test item.

2. The software test framework of claim 1, the test items being capable of being coupled to the test context, test data, and test logic.

3. The software test framework of claim 1, further including a test scenario composed from one or more test items, the test scenario being executable by the software test framework to test a piece of software.

4. A computer-readable medium having one or more data structures stored thereon for use by a computing system to facilitate a software test framework, the one or more data structures comprising:
a statement class for defining attributes and services connected with the treatment of a test item or a test scenario;
a managed item class for defining attributes and services connected with a test item that is implemented with code that behaves and provides results defined by a predetermined architecture; and
an unmanaged item class for defining attributes and services connected with a test item that is implemented outside of the predetermined architecture.

5. The one or more data structures of claim 4, further including a variation class for defining attributes and services connected- with the representation of a grouping of statements together in combination and collectively defining a test unit.

6. The one or more data structures of claim 4, further including a parallel class for defining attributes and services connected with causing test items to be executed in parallel.

7. The one or more data structures of claim 4, further including a sequence class for defining attributes and services connected with causing test items to be executed in sequence.

8. The one or more data structures of claim 4, further including a for class for defining attributes and services connected with a looping control statement that executes test items a specified number of times.

9. The one or more data structures of claim 4, further including a thread class for defining attributes and services connected with defining an independent path of execution for test items.

10. The one or more data structures of claim 4, further including a remote class for defining attributes and services connected with the declaration of executing test items on a remote machine by specifying a location and accessing information.

11. In a computer system including a display, a user input facility, and an application executed thereon for presenting a user interface on the display, the application comprising:
a first portion of the user interface for presenting a number of statements from which to build a test scenario, the number of statements including a sequence statement for declaring executable instructions for causing test items to be executed in a particular order, the number of statements further including a parallel statement for declaring executable instructions for causing test items to be executed in parallel.

12. The application of claim 11, wherein the number of statements further includes a remote statement for declaring executable instructions for causing test items to be executed on a remote computer by defining the location of the remote computer and access information, the number of statements further including a thread statement for declaring executable instructions for causing an independent path of execution to occur for a particular test item, the number of statements further including a for statement for declaring executable instructions for implementing a loop in which a test item is executed for a specified number of times, the number of statements further including a user context statement for declaring executable instructions that specify the level of user access in which to execute a test, the number of statements further including a leak detection statement for declaring executable instructions for detecting whether a memory leak has occurred after the execution of a test item, the number of statements further including a performance measurement statement for declaring executable instructions for measuring computer performance after execution of a test item, the number of statements further including a generator statement for declaring executable instructions for generating data for a test item, the number of statements further including a validator statement for declaring executable instructions for validating data for a test item, the number of statements further including a coverage statement for declaring executable instructions for determining the code coverage of the execution of a particular test item, the number of statements further including a logging statement for declaring executable instructions for logging test activities in connection with a test item, the number of statements further including an error handling statement for declaring executable instructions for reporting errors generated as a result of the execution of a test item, the number of statements further including a deadlock detection statement for declaring executable instructions for determining whether a deadlock has occurred, the number of statements further including a variation statement for declaring executable instructions to group together a set of test items for execution.

13. The application of claim 11, wherein the number of statements further includes a manage item statement for inserting a particular piece of test code written in a predetermined architecture, the number of statements further including an unmanaged item statement for the inserting of test code written external to the predetermined architecture.

14. The application of claim 11, further including a second portion of the user interface for presenting a work area to create a test scenario in the form of a type of graphical representation that gives a visual feedback of the flow of the test scenario.

15. The application of claim 11, further including a third portion of the user interface for representing an area for selecting a piece of code in a library associated with a managed item statement or an unmanaged item statement, the third portion of the user interface allowing the receipt of parameters connected with the managed item statement or the unmanaged item statement.

16. A computer-implemented method for testing software, comprising:
discovering published test items, each test item being disassociated with test context, test data, and test logic;
creating test scenarios from combinations of test items, each test scenario organized as a tree structure with nodes that are linked together in a hierarchical fashion; and
executing test scenarios using a software test framework to produce test results, the test results being analyzable to verify and validate a piece of software.

17. The computer-implemented method of claim 16, wherein the act of creating includes selecting a test item from a group of managed test items or unmanaged test items, each managed test item being written in a predetermined architecture, each unmanaged test item being written external to the predetermined architecture.

18. The computer-implemented method of claim 16, further including reducing a test scenario to a customizable, tag-based description stored in a file.

19. The computer-implemented method of claim 18, further including validating the customizable, tag-based description stored in the file.

20. The computer-implemented method of claim 19, further including instantiating statements in the customizable, tag-based description stored in the file and executing the instantiated statements.

21. A computer-readable medium having computer-executable instructions stored thereon that implements a method for testing software, the method comprising:
discovering published test items, each test item being disassociated with test context, test data, and test logic;
creating test scenarios from combinations of test items, each test scenario organized as a tree structure with nodes that are linked together in a hierarchical fashion; and
executing test scenarios using a software test framework to produce test results, the test results being analyzable to verify and validate a piece of software.

22. The computer-implemented method of claim 21, wherein the act of creating includes selecting a test item from a group of managed test items or unmanaged test items, each managed test item being written in a predetermined architecture, each unmanaged test item being written external to the predetermined architecture.

23. The computer-implemented method of claim 21, further including reducing a test scenario to a customizable, tag-based description stored in a file.

24. The computer-implemented method of claim 23, further including validating the customizable, tag-based description stored in the file.

25. The computer-implemented method of claim 24, further including instantiating statements in the customizable, tag-based description stored in the file and executing the instantiated statements.
